(19) United States
(12) Patent Application Publication
(10) Pub. No.: US 2013/0095162 A1
(43) Pub. Date: Apr. 18, 2013

(54) Adhesive insect repellent strip

(71) Applicant: Mary Kathleen Quinn, Bonsall, CA (US)

(72) Inventor: Mary Kathleen Quinn, Bonsall, CA (US)

(21) Appl. No.: 13/317,471

(22) Filed: Oct. 18, 2011

(51) Int. Cl. A01N 25/08; A01P 17/00

(52) U.S. Cl. 424/409

(57) ABSTRACT

An adhesive insect repellent strip that provides a practical, effective, safer way to use plant-derived and synthetic chemical insect repellents, comprising an absorbent material layer affixed with polyurethane to an adhesive-backed foam mounting layer. An aluminum foil layer, secured between the polyurethane and adhesive-backed foam mounting layer, serves a unique dual function as a barrier to protect the adhesive properties of the mounting layer below, and as a hermetic packaging wrapper to encompass the entire strip after saturation with repellent. The adhesive insect repellent strip is self contained, durable and flexible, may be cut to size, affixes to most clean, dry surfaces without the insect repellent coming into contact with the wearer's skin or the surface where attached, can be resaturated for extended use, and is easily removed without leaving residue when no longer effective or desired.

### FIELD OF THE INVENTION

The present invention relates to the field of insect repellent applications and devices, namely an adhesive insect repellent strip that provides a practical, effective, safer way to use insect repellent without the insect repellent coming into direct contact with the skin of the user or the surface where it is adhesively secured to repel insects, and is easily removed when no longer effective or desired without leaving residue.

### BACKGROUND OF THE INVENTION

Mosquitoes, flies, gnats, fleas and ticks are a common problem. Conventional applications of insect repellents currently available to the consumer are inadequate, presenting several inefficiencies and hazards.

Sprays and lotions can be toxic, irritate the skin, harm fabric and other materials, and leave a greasy, unpleasant coating. Sprays and lotions are absorbed into the skin, directly exposing the wearer to the same chemicals intended to protect them from insects, possibly resulting in allergic or other physical reactions. Additionally, sprays fill the atmosphere with chemicals and may be inhaled or get into the users eyes, on food, or other unintended places.

Flea and tick collars for pets rub the skin, potentially causing chemical burns, allergic reactions and rashes, and present a possible choking hazard. Wrist bands infused with repellent also come into direct contact with the wearer's skin and are limited to where they may be worn. Clip-on fan insect repellent devices are bulky, limited to where they may be attached or worn, and are relatively complex and expensive, requiring the purchase of repellent inserts and batteries at an additional cost. Clip-on fans may not be used indoors or in enclosed places, and do not work well if the wearer is moving.

Adhesive patches are typically limited by the amount and type of insect repellent used, such as plant-derived essential oil, due to the inferior, poor quality of the material they are made of, similar to that of a decorative sticker, resulting in limited potency and thus effectiveness in actually repelling insects. The more elaborate patches often incorporate multiple layers, such as a top osmosis layer, a control layer with evaporation ports, layers to encapsulate breakable packets of insect repellent, layers to create an electrical charge to facilitate evaporation, and so on. These patches often require transforming an insect repellent from a liquid into a solid gel or wax, resulting in an overly complicated, less effective, expensive patch. Some additional limitations of insect repellent patches heretofore include:

(a) They may not be cut to size to accommodate varied uses without compromising their structure and ability to function.

(b) They require additional hermetic packaging to contain and protect the insect repellent from evaporating prior to use.

(c) Once applied, one may not extend the life of the patch by adding more insect repellent.

### SUMMARY OF THE INVENTION

Accordingly, the objectives of the present invention are to provide an improved, safer way to use insect repellent, comprising an absorbent material layer, a bonding layer, a barrier layer, which extends to serve a dual function as a hermetic packaging wrapper, and an adhesive mounting layer on its bottom side for attachment.

### Advantages

Several advantages of one or more aspects of the adhesive insect repellent strip are as follows: to provide a self contained, convenient, disposable means of using insect repellent, that provides passive, longer lasting evaporation for both plant-derived and synthetic chemical insect repellents, in which the insect repellent does not come into contact with the wearer's skin or the surface where applied, that is flexible and durable, that adheres to most clean, dry surfaces, that may be cut to size, that can be resaturated with insect repellent, that can be removed when no longer effective or desired without leaving residue, that is relatively inexpensive, and that can be easily manufactured in a variety of colors and sizes.

### BRIEF DESCRIPTION OF DRAWINGS

FIG. 1 illustrates the adhesive insect repellent strip in accordance with the invention showing the dual purpose aluminum foil sheet barrier layer fully extended prior to folding for use as a hermetic packaging wrapper large enough to encompass the entire strip after saturating the top absorbent material layer with insect repellent.

FIG. 2 illustrates the removal of the protective liner on the bottom of an adhesive insect repellent strip prior to use, with the dual purpose aluminum foil barrier layer remaining intact after the removal of the extended wrapper portion.

FIG. 3 illustrates a dog collar with an adhesive insect repellent strip securely adhered to the outer surface.

### DETAILED DESCRIPTION OF INVENTION

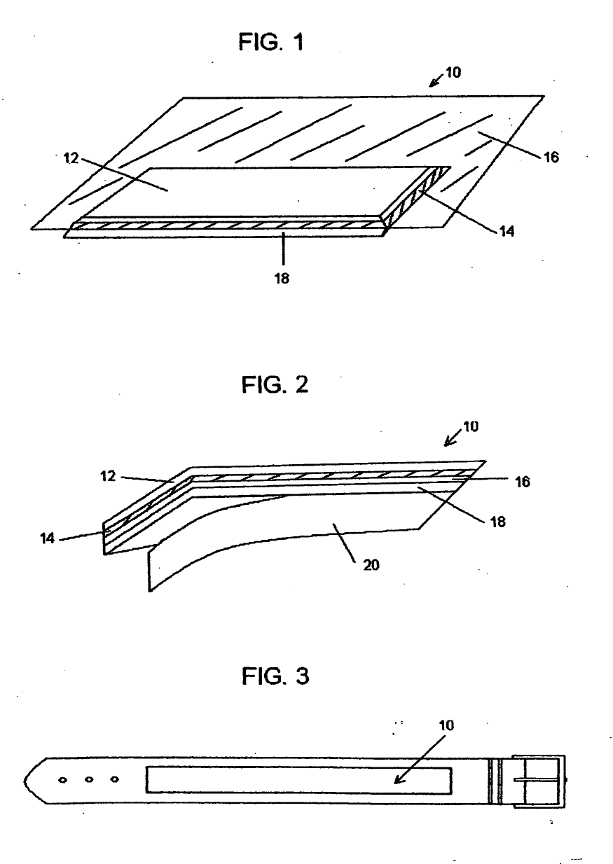

An adhesive insect repellent strip 10 as shown in FIG. 1 comprises an absorbent material 12, ⅛″ thick, medium density, wool felt being the preferred embodiment, attached with a bonding layer 14, 1/32″ thick layer of flexible, impermeable polyurethane being the preferred embodiment, to an aluminum foil barrier layer 16 large enough to additionally serve a dual purpose as a hermetic packaging wrapper to encompass and insulate the entire strip. The foil barrier layer 16 is affixed to adhesive-backed foam 18, 1/16″ thick double-sided adhesive foam mounting tape being the preferred embodiment, with the absorbent material 12, the bonding layer 14, and the adhesive-backed foam 18 being the same width and length in order to achieve evenly layered construction. After the absorbent material layer 12 is saturated with a plant-derived or synthetic chemical insect repellent, the extended portion of the dual function aluminum foil barrier layer 16 folds over to encompass the adhesive insect repellent strip 10, serving to insulate and retain the insect repellent prior to use.

The comprised adhesive insect repellent strip 10, with the aluminum foil wrapper portion of the barrier layer 16 removed, is applied to a clean, dry surface by removing the protective liner 20 from the bottom portion of the adhesive-backed foam 18 of the invention as shown in FIG. 2.

The adhesive insect repellent strip 10 may be used on most clean, dry surfaces including nylon mesh, cotton and synthetic fabrics, leather, plastic, tile and wood. The adhesive insect repellent strip may be used on pet collars as shown in FIG. 3 as well as on horse bridles, hats, shoes and clothing, and may be resaturated with insect repellent for extended protection, or easily removed when no longer desired without leaving residue.

I claim:

1. An adhesive insect repellent strip comprising:
a) an absorbent material layer,
b) a bonding layer,
c) a barrier layer, and
d) an adhesive mounting layer.

2. The adhesive insect repellent strip of claim 1 wherein the absorbent material layer will not disintegrate when saturated with plant-derived or synthetic chemical insect repellent.

3. The adhesive insect repellent strip of claim 1 wherein a bonding layer provides a cohesive, flexible, impermeable seal between the absorbent material layer and the barrier layer that will not be compromised or weakened when the absorbent material layer is saturated with insect repellent.

4. The adhesive insect repellent strip of claim 1 wherein the barrier layer protects the adhesive properties of the adhesive mounting layer and may be extended to serve a dual function as a hermetic wrapper.

5. The adhesive insect repellent strip of claim 1 wherein the insect repellent does not come into contact with the wearer's skin or surface where attached.

6. The adhesive insect repellent strip of claim 1 wherein the adhesive mounting layer is easily attached and removed without leaving residue.

7. The adhesive insect repellent strip of claim 1 wherein the device may be cut to size without compromising its structure or its ability to function.

8. The adhesive insect repellent strip of claim 1 wherein the absorbent material layer may be resaturated with insect repellent for extended use.
